(19) United States
(12) Patent Application Publication
(10) Pub. No.: US 2021/0354643 A1
(43) Pub. Date: Nov. 18, 2021

(54) MULTISTAGE AIRBAG IMPACT ABSORPTION APPARATUS OF VEHICLE

(71) Applicant: SMART AIR CHAMBER CO., LTD., Seoul (KR)

(72) Inventors: Kyung Won YUN, Seoul (KR); In Song PARK, Bucheon-si (KR)

(73) Assignee: SMART AIR CHAMBER CO., LTD., Seoul (KR)

(21) Appl. No.: 16/490,661

(22) PCT Filed: Mar. 11, 2019
(86) PCT No.: PCT/KR2019/002195

§ 371 Date: Sep. 3, 2019

(30) Foreign Application Priority Data
Jan. 11, 2019 (KR) 10-2019-0003679

(51) Int. Cl. B60R 19/20; B60R 19/03

(52) U.S. Cl. CPC B60R 19/205; B60Y 2200/142; B60R 19/03

(57) ABSTRACT

A multistage airbag impact absorption apparatus of a truck is made of urethane and characterized by an airbag that has a plane shape on one side and an elliptical shape on the other side and has two air perforations attached with a perforated part and air inlet and outlet part, a core part formed with many core perforations attached to the airbag, a base plate formed with plate perforations and attached to the core part that helps the perforated part project out upon collision with the air inlet and outlet part, an air inlet and outlet part attached to air perforations of the airbag, core perforations of the core part and plate perforations of the base plate, a second impact absorption part attached to both sides of the base plate, and a second base plate that is attached to the truck body and supports the second impact absorption part.

### BACKGROUND OF THE INVENTION

### 1. Field of the Invention

This invention relates to an impact absorption apparatus of a truck. In general, large trucks generate a large impact upon collision and must have an impact absorption structure different from ordinary vehicles. In addition, there needs to be a countermeasure for the frequent collision on the front right side of trucks when loading and unloading goods to and from large ships at a port.

### 2. Description of Related Art

The existing technology related to this invention is presented in the registered patent of the Republic of Korea no. 10-1033790 (published on May 13, 2011). FIG. 1 is a block diagram of an existing external airbag of vehicle. In FIG. 1, the existing external airbag system of vehicle is comprised of a cushion (20) installed on the front side of the vehicle, sensor unit that detects obstacles ahead, and control unit (40) that operates the cushion (20) in advance when the vehicle is expected to collide with an obstacle ahead based on signals sent by the sensor unit. A radar sensor (30a) and/or a camera (30b) can be used as the sensor unit. The cushion (20) is installed on a recess (51) prepared in the back beam (50) on the rear side of the bumper cover (10). In addition, the bumper cover (10) deviates from its position due to the deploying force of the cushion (20) and moves forward. More specifically, the side part rotates toward the front side around the central part. This rotating motion is assisted by preparing a seam line (13) in the vertical direction on the inside of the bumper cover (10) that corresponds to the boundary with the license plate (4). When fully operated, the cushion (20) expands to become larger on the side part than the central part. The degree of widening or opening of the side part of the bumper cover (10) is adjusted by a tether (95) connecting between the bumper cover (10) and back beam (50). On the one hand, the bumper cover (10) includes a bumper skin (11) and absorber (12). A front side member (3) is connected to the back of the back beam (50).

### SUMMARY OF THE INVENTION

The existing technology comprised as above operates the cushion based on sensing of the sensor prior to a collision. There is a problem in which the cushion is operated by malfunctioning of the sensor, and another problem is the inability to respond to collisions depending on the size of the impact. Therefore, the purpose of this invention is to attach the apparatus to a large truck so that varying impact can be absorbed. In addition, another purpose of this invention is to cope with frequent collision accidents by attaching the apparatus to the front side of a large truck that enters into large ships at a port. In addition, another purpose of this invention is to increase productivity of various parts through mass production and easier assembly.

The multistage airbag impact absorption apparatus of large truck of this invention with the purposes is made of urethane and characterized by an airbag that has a plane shape on one side and an elliptical shape on the other side and has two air perforations attached with a perforated part and air inlet and outlet part, a core part formed with many core perforations attached to the airbag, a base plate formed with plate perforations and attached to the core part that helps the perforated part project out upon collision with the air inlet and outlet part, an air inlet and outlet part that is attached to air perforations of the airbag, core perforations of the core part and plate perforations of the base plate, a second impact absorption part attached to both sides of the base plate, and a second base plate that is attached to the truck body and supports the second impact absorption part.

### Advantageous Effects

This invention comprised as above has an effect of reducing impact and repulsive force in multiple stages according to the size of impact during collisions of a vehicle. In addition, the impact absorption apparatus of this invention has an effect of increasing productivity by mass producing each component and making assembly of each component easy. In addition, another effect of this invention is to prepare for collisions when a truck enters into large ships at a port and to protect the vehicle and passengers from damages caused by collisions.

### BRIEF DESCRIPTION OF THE DRAWINGS

FIG. 1 is a block diagram of an existing external airbag system of a vehicle.

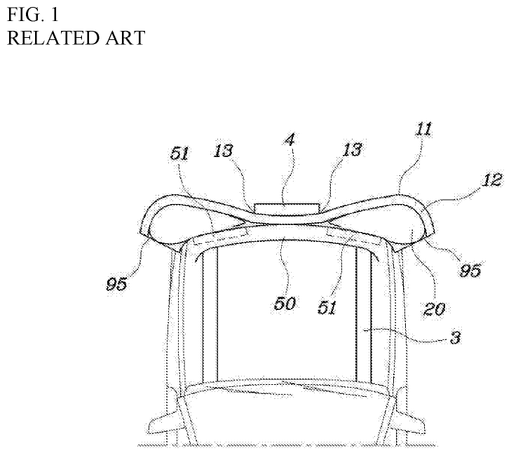

FIG. 2 is a perspective view of a multistage airbag impact absorption apparatus of a truck according to an embodiment of the invention.

FIG. 3 is an exploded perspective view of the multistage airbag impact absorption apparatus.

FIG. 4 is a cross-sectional diagram of the multistage airbag impact absorption apparatus when there is no collision.

FIG. 5 is an enlarged diagram of the air inlet and outlet part of the multistage airbag impact absorption apparatus when there is no collision.

FIG. 6 is an enlarged diagram of the air inlet and outlet part of the multistage airbag impact absorption apparatus upon collision.

FIG. 7 is an example of the multistage airbag impact absorption apparatus attached to the truck.

### DETAILED DESCRIPTION OF THE INVENTION

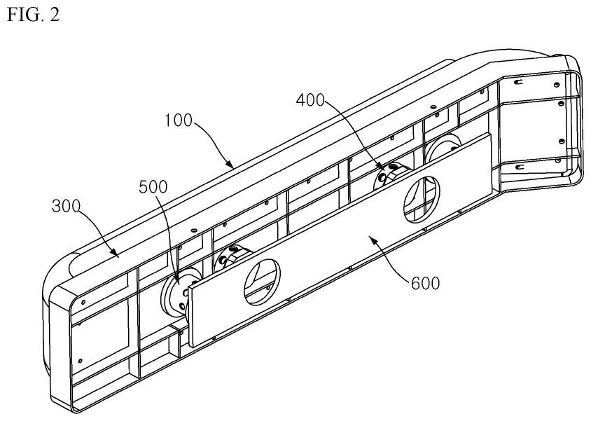

The multistage airbag impact absorption apparatus of a truck of this invention with the purposes can be described using FIGS. 2 through 7 as follows.

FIG. 2 is a perspective view of the multistage airbag impact absorption apparatus of a truck of this invention. In FIG. 2, the multistage airbag impact absorption apparatus of a truck (1000) of this invention is made of urethane and has a plane shape on one side and an elliptical shape on the other side. The two sides are combined to form the airbag. The apparatus is characterized by an airbag (100) that has two air perforations attached with a perforated part (700) on the plane part and air inlet and outlet part and can be contracted or expanded, a core part (200) bent on one side and formed with many core perforations attached to the airbag as one body with the plane shape, a base plate (300) bent on one side and attached to the core part that forms second plate perforations to make the perforated pin project out upon collision with the first plate perforations projecting the air inlet and outlet part, an air inlet and outlet part (400) that is attached to air perforations of the airbag, core perforations of the core part and first plate perforations of the base plate, a second impact absorption part (500) attached to both sides of the base plate, and a second base plate (600) that is attached to the truck body and supports the second impact absorption part. The airbag is characterized by a bent shape on one side. The airbag uses urethane or, desirably, thermoplastic polyurethane (TPU).

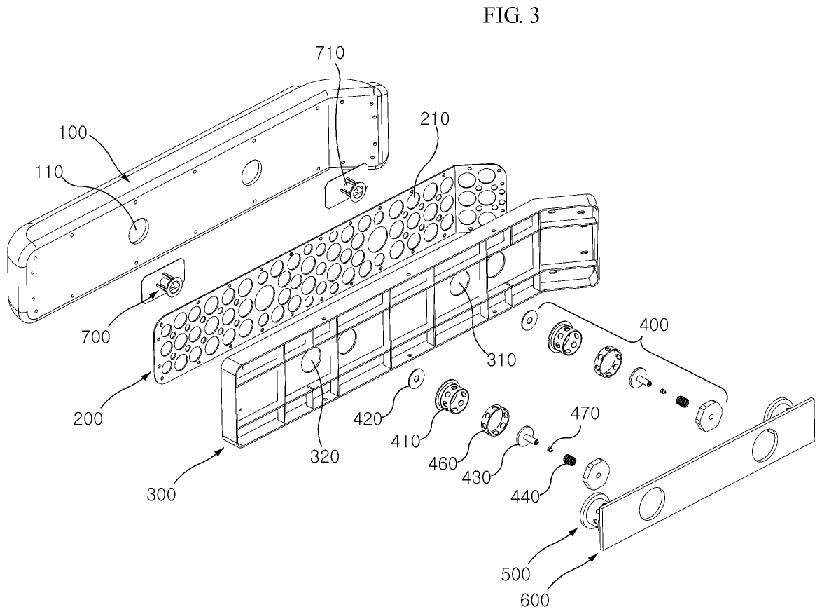

FIG. 3 is an exploded perspective view of the multistage airbag impact absorption apparatus of a truck of this invention. In FIG. 3, the multistage airbag impact absorption apparatus of a truck of this invention is made of urethane and has a plane shape on one side and an elliptical shape on the other side. The apparatus is characterized by an airbag (100) that has two air perforations (110) attached with a perforated part (700) and air inlet and outlet part (400), a core part (200) formed with many core perforations (210) attached to the airbag, a base plate (300) attached to the core part that forms a second perforated plate (320) to make the perforated part project out upon collision with the first perforated plate (310) projecting the air inlet and outlet part, an air inlet and outlet part (400) that is inserted and attached to air perforations (110) of the airbag (100), core perforations (210) of the core part (200) and first plate perforations (310) of the base plate (300) where a check valve base (410) is inserted into and settled on the air perforations (110), core perforations (210) and first plate perforations (310), a rubber packing (420) settles on the back of the check valve base (410), a hollow operating spool (430) is inserted and attached to the back of the rubber packing (420), a spring (440) is inserted and attached externally to the operating spool (430), a spring stopper and cylinder guide part (450) is attached to the back of the spring (440), a spring space (460) is attached between the base plate (300) and spring stopper and cylinder guide part (450) on the outside of the check valve base (410) and an air injection valve (470) is inserted and attached to the end of the operating spool (430), a second impact absorption part (500) made of steel attached to the second plate perforations (320) of the base plate (300) to absorb impact by crushing the hollow interior, and a second base plate (600) that is attached to the truck body and supports the second impact absorption part (500).

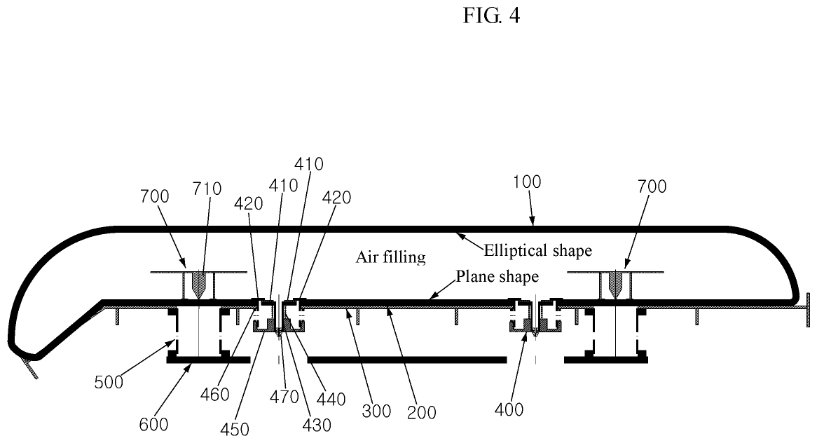

FIG. 4 is a cross-sectional diagram of the multistage airbag impact absorption apparatus of a truck applied to this invention when there is no collision. In FIG. 4, the multistage airbag impact absorption apparatus of a truck when there is no collision is comprised of an airbag (100), a perforated part (700) attached to the plane shape inside the airbag, an air inlet and outlet part (400) attached to the plane shape of the airbag, core part (200) and base plate (300) where a check valve base (410) is inserted into and settled on air perforations (110), core perforations (210) and first plate perforations (310), a rubber packing (420) is settled on the back of the check valve base (410), an operating spool (430) with hollow interior is inserted and attached to the back of the rubber packing, a spring (440) is externally inserted and attached to the operating spool, a spring stopper and cylinder guide part (450) is attached to the back of the spring, a spring space (460) is attached between the base plate (300) and spring stopper and cylinder guide part (450) on the outside of the check valve base (410) and an air injection valve (470) is inserted and attached to the end of the operating spool (430), a second impact absorption part (500) with hollow interior attached to the base plate, and a second base plate (600) that is attached to the truck body and supports the second impact absorption part (500). In the above, the air inlet and outlet part (400) usually shows higher air pressure inside the airbag (100) than atmospheric pressure by filling air through the air injection valve (470). The operating spool (430) is pushed upward by force of the spring (440), and the operating spool (430) pushes the rubber packing (420) upward so that the rubber packing (420) touches the check valve base (410) without distance to prevent external leakage of air from the airbag.

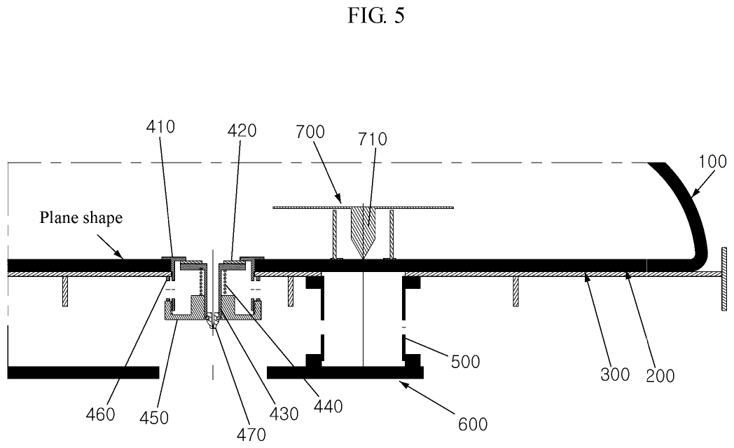

FIG. 5 is an enlarged diagram of the air inlet and outlet part of the multistage airbag impact absorption apparatus of a truck applied to this invention when there is no collision. In FIG. 5, the air inlet and outlet part (400) of the airbag impact absorption apparatus of a truck of this invention pushes the operating spool (430) upward using elastic force of the spring (440) attached to the operating spool (430) and spring stopper and cylinder guide part (450) if the airbag (100) is filled with air to certain pressure through the air injection valve (470). The rubber packing (420) is moved up by the operating spool to touch the check valve base (410) without distance, preventing leakage of air from the airbag.

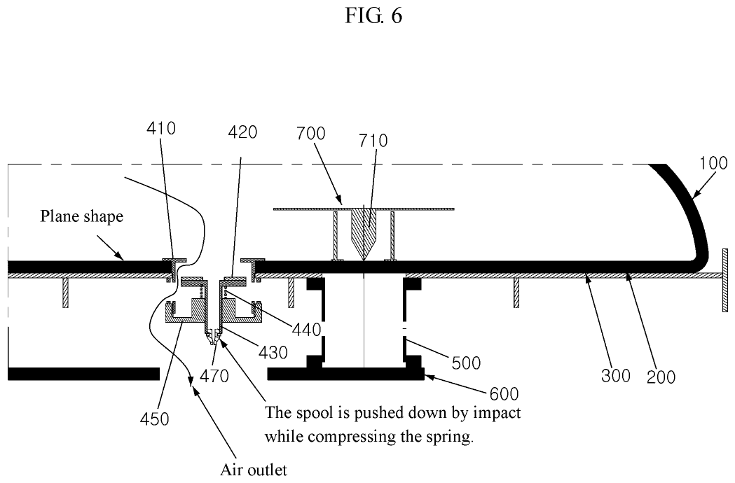

FIG. 6 is an enlarged diagram of the air inlet and outlet part of the multistage airbag impact absorption apparatus of a truck applied to this invention during a collision. In FIG. 6, stage 1 is where the vehicle collides with the airbag at a small or normal impact. Air pressure of the airbag (100) increases sharply, pushing the operating spool (430) and rubber packing (420) downward at the same time to separate the distance between the check valve base (410) and rubber packing (420). This separation allows air inside the airbag (100) to flow out. After the impact, elastic force of the spring (440) moves the operating spool (430) and rubber packing (420) upward to close the separation and absorb the impact during the collision and repulsive force after the collision. In addition, when the impact is large, air flows out through the air inlet and outlet part (400) to absorb the impact. At the same time, the perforated pin (710) on the perforated part (700) attached inside the airbag (100) perforates the rear side of the airbag (100) to project out of the core perforations (210) of the core part (200) and inner hollow of the second impact absorption part (500), absorbing the impact and repulsive force. In addition, when the impact is even larger, the air inlet and outlet part (400), perforated part (700) and second impact absorption part (500) are operated simultaneously to absorb the impact and repulsive force after the impact. As explained above, the multistage airbag impact absorption apparatus of a truck of this invention absorbs the impact during a collision and repulsive force after a collision by operating the air inlet and outlet part (400), perforated part (700) and second impact absorption part (500) separately or together depending on the size of the impact during a collision. The air injection valve is a common air check valve that opens while injecting air and closes after air injection.

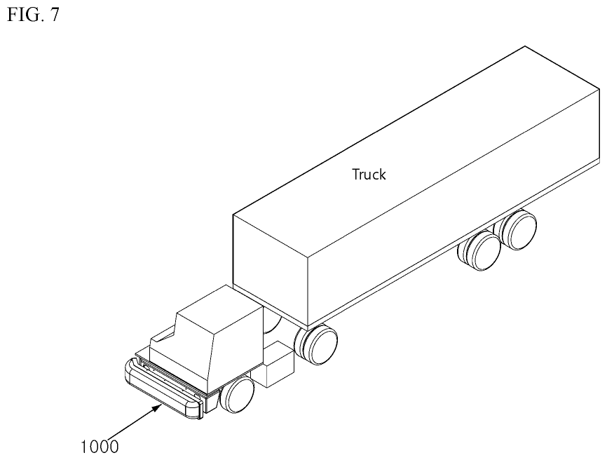

FIG. 7 is an example of the multistage airbag impact absorption apparatus of a truck of this invention attached to the truck. In FIG. 7, the shape of the airbag (100) is bent on the right side. The structure shows that the airbag (100) bent on the right side can be attached to the right side of a large truck that often collides with ships at a port on the front right side.

1. A multistage airbag impact absorption apparatus of a truck intended to reduce an impact upon collision and a repulsive force after the impact, comprising:
an airbag (100) that has a plane shape on one side and an elliptical shape on the other side, has two air perforations (110) attached with a perforated part (700) on the plane part and air inlet and outlet part (400), and can be contracted or expanded;
a core part (200) bent on one side and formed with many core perforations (210) attached to the airbag;
a base plate (300) bent on one side and attached to the core part that forms second plate perforations (320) to make the perforated part project out upon collision with the first plate perforations (310) projecting the air inlet and outlet part;
an air inlet and outlet part (400) that is attached to air perforations (110) of the airbag (100), core perforations (210) of the core part (200) and first plate perforations (310) of the base plate (300) where a check valve base (410) is inserted into and settled on the air perforations (110), core perforations (210) and first plate perforations (310), a rubber packing (420) settles on the back of the check valve base (410), a hollow operating spool (430) is inserted and attached to the back of the rubber packing (420), a spring (440) is inserted and attached externally to the operating spool (430), a spring stopper and cylinder guide part (450) is attached to the back of the spring (440), a spring space (460) is attached between the base plate (300) and spring stopper and cylinder guide part (450) on the outside of the check valve base (410) and an air injection valve (470) is inserted and attached to the end of the operating spool (430);
a second impact absorption part (500) made of steel that is attached to the second plate perforations (320) of the base plate (300) and has hollow interior; and
a second base plate (600) that is attached to the truck body and supports the second impact absorption part (500).

2. The multistage airbag impact absorption apparatus of claim 1, wherein each of the airbag, the core part and the base plate is bent on one side.

3. The multistage airbag impact absorption apparatus of claim 1, wherein the multistage airbag impact absorption apparatus includes two first plate perforations and second plate perforations,
wherein the first plate perforations are formed on the inside and the second plate perforations are formed on the outside of the first plate perforations.

4. The multistage airbag impact absorption apparatus of claim 1, wherein the airbag is comprised of thermoplastic polyurethane (TPU).
